(19) United States
(12) Patent Application Publication
(10) Pub. No.: US 2009/0211376 A1
(43) Pub. Date: Aug. 27, 2009

(54) Device and method for measuring torsional moment

(76) Inventor: Franck Landrieve, Fondettes (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 11/919,115

(22) PCT Filed: Apr. 24, 2006
(86) PCT No.: PCT/FR2006/000908

§ 371 Date: Jan. 20, 2009

(30) Foreign Application Priority Data
Apr. 22, 2005 (FR) 0504088

(51) Int. Cl. G01L 3/10

(52) U.S. Cl. 73/862.333

(57) ABSTRACT

A device for measuring the torque applied to a kinematic assembly including a detection means capable of supplying a signal representative of the angular position A₁ of a first element of said kinematic assembly, a detection means capable of supplying a signal representative of the angular position A₂ of a second element of said kinematic assembly, a memory for storing a correction value C, and a processing unit provided with means for applying the correction value C to one of the angular positions A₁ or A₂, where C=A₂−A₁ when the torque applied to the kinematic assembly is zero.

### BACKGROUND OF THE INVENTION

1. Field of the Invention

The present invention relates to the field of measuring the torque applied to a kinematic assembly, in particular a steering control, for example for a motor vehicle. The invention may relate to the power-assisted steering devices used in motor vehicles.

2. Description of the Related Art

In power-assisted steering devices, the mechanical linkage between the steering wheel and the steerable wheels of the vehicle includes the steering wheel which may be actuated by the driver, a steering column shaft transmitting the angular movements of the steering wheel to a torsion shaft, a torsion bar transmitting the angular movements of the steering column shaft to a rack and pinion system, itself actuating the orientation of the wheels, if appropriate by way of link rods, and a torque sensor associated with the torsion bar. The torsion bar deforms in torsion by an angle proportional to the torque exerted by the driver on the steering wheel and is dimensioned so that this angular deformation in torsion is sufficiently large to be detectable by a sensor.

The measurement of the torque exerted by the driver on the steering wheel shaft is an important parameter in power-assisted steering systems. This is because the initiation of the steering assistance is particularly dependent on this torque. The signal emitted by the sensor and representative of the torque exerted is transmitted to a steering assist computer which may thus give the orders ad hoc to the steering assist member, for example an electric motor in the case of an electric servo-assisted steering system.

The electric assist motor may be associated with the column shaft or with an intermediate shaft situated in the continuation of the steering column shaft and connected thereto by one or more universal joints. The motor may also be associated with the steering column in the region of the rack pinion. Finally, the motor may be associated with the rack and actuate it directly via a mechanical member associated with said rack. Reference may be made in this respect to document EP-A-1 298 784.

In conventional devices, the ends of the torsion shaft are equipped with sensors and encoder disks for measuring the angular torsion deviations between the two ends of the torsion bar in order to deduce a torque therefrom. Reference may be made to document FR-A-2 738 339 or else FR-A-2 821 931.

However, these devices require the use of specific elements which are specially adapted to the structure of the torsion bars and which are therefore expensive. Moreover, the precision of the signal giving the value of the torque is directly linked to the precision of the sensors used.

Document EP-A-1 239 274 describes an analog torque-measuring device in a steering column that includes a test body, two pulse generators mounted on the test body and two analog magnetic sensors. This device is bulky and costly.

### SUMMARY OF THE INVENTION

The embodiments of the device and methods described herein are presented to overcome these disadvantages.

In an embodiment, particularly precise torque measurement using economical components is achieved.

The device for measuring the torque applied to a kinematic assembly including a control shaft includes a detection means capable of supplying a signal representative of the angular position of a first element of the kinematic assembly, a detection means capable of supplying a signal representative of the angular position of a second element of the kinematic assembly, one of the detection means including an encoder, a memory for storing a correction value, and a processing unit provided with means for applying the correction value to the angular position of the first or the second element of the kinematic assembly, the correction value being equal to the difference between the angular position of the second element and the angular position of the first element when the torque applied to the kinematic assembly is zero. It is thus possible to calibrate the correction value in an extremely simple manner during tests on the vehicle as it leaves the production plant, and also subsequently during maintenance operations on the vehicle. The detection means may be arranged at locations where they may be readily housed while minimizing their influence on the space requirement.

The control shaft may be a steering column shaft.

The detection means may be of the digital output signal type. The output signal may be analyzed to provide information to a correction table including a plurality of points, and not a single fixed gain. The output signal of the detection means may exhibit significant linearity faults that the processing unit is capable of correcting thanks to the correction table stored in the memory. A measuring device which is precise and nevertheless mechanically simple is thus made available.

Advantageously, at least one detection means is mounted in a steering column of the kinematic assembly. The kinematic assembly may include a torsion bar separated from the detection means.

In one embodiment, a detection means is mounted on a steering element of the kinematic assembly, the angular position of which is representative of the turning angle of the vehicle wheels, in particular the front wheels. The kinematic assembly may be intended to be mounted in the vehicle. The steering element may be the control shaft, the input shaft of a rack pinion or else a rotating member of a steering motor, for example a shaft or a rotor. Preferably, said detection means is mounted on a steering element of the kinematic assembly, the angular position of which is representative in a direct or linear manner of the turning angle of the vehicle wheels. The detection means may include encoders mounted at the opposite ends of a torsion bar.

In one embodiment, the detection means are arranged at a distance from a torsion bar.

In one embodiment, the detection means includes encoders mounted beyond the opposite ends of a torsion bar.

Advantageously, the detection means includes absolute angular position sensors.

In one embodiment, at least one detection means includes a revolution counter.

In one embodiment, the detection means includes magnetosensitive sensors and multipole magnetic encoders. The sensors may be equipped with Hall-effect cells. The encoders may include magnetized plastoferrite or elastoferrite rings.

In one embodiment, at least one detection means is mounted on a rolling bearing race.

In one embodiment, the detection means may include a sensor mounted on a non-rotating rolling bearing race and an encoder mounted on a rotating rolling bearing race. Use may thus be made of instrumented rolling bearings serving both to support a rotating element and to detect an angular position.

The method of measuring the torque applied to a kinematic assembly including a control shaft includes the following steps:
measurement of the angular position of a first element of the kinematic assembly with first detection and measurement means;
measurement of the angular position of a second element of the kinematic assembly with second detection and measurement means, one of the elements being the shaft, the second detection means including an encoder mounted on the shaft; and
application of a correction value to the angular position of the first or second element of the mechanical assembly.

The correction value is equal to the difference between the angular position of the second element of the mechanical assembly and the angular position of the first element of the mechanical assembly when the torque applied to the kinematic assembly is zero.

In one embodiment, the correction value is established and recorded by relative calibration of the two detection and measurement means during an operation of the kinematic assembly at zero or negligible torque. Instrumented rolling bearings may be used as detection and measurement means.

Advantageously, the angular positions of the first and second elements of the kinematic assembly are absolute angular positions. Thus, it is possible to know the absolute angular position of the steering column and the torsion on the torsion bar and, where appropriate, the combined torsions of all the elements arranged between the two detection assemblies with a precision which depends essentially on the resolution and repeatability of the measurement of each detection assembly.

The device may be applied to a steering system with or without a torsion bar. All that is required is to place the instrumented rolling bearings or the detection assemblies at the two ends of the kinematic linkage, that is to say one as close as possible to the vehicle wheels, and the other as close as possible to the steering wheel. The torsion measured is thus that of all the kinematic members of the steering system and gives the difference between the setpoint, that is to say the angular position of the steering wheel, and the turning position of the wheels.

The absolute position information given by the detection assemblies or the instrumented rolling bearings may be used for other systems connected with the angular position of the steering wheel, for example a system for controlling the course of the vehicle.

By virtue of the embodiments described herein, use may be made of detection assemblies which may be integrated into many locations of the mechanical steering linkage which connect the wheels to the steering wheel. The detection assemblies for detecting the absolute angular displacement values may be integrated into conventional instrumented rolling bearings and do not individually require excessive levels of precision, the measurement deviations due to the individual precision levels being compensated for by the stored calibration of one detection assembly with respect to the other. The embodiments described herein thus make it possible to obtain, at a minimum cost, a device which is compact, reliable and easy to arrange in a steering mechanism.

### BRIEF DESCRIPTION OF THE DRAWINGS

The present invention will be better understood on studying the detailed description of some embodiments given by way of non-limiting examples and illustrated by the appended drawings, in which:

FIG. 1 is a schematic view of a motor vehicle steering system;

FIG. 2 is a front elevation view of a detection assembly;

FIG. 3 is a view in axial section of the assembly shown in FIG. 2;

FIG. 4 is a schematic view of the method step of computing the angle using a detection assembly;

FIG. 5 is a view in axial section of an instrumented rolling bearing mounted in a steering system;

FIG. 6 is a view in axial section of the lower end of a torsion shaft equipped with an instrumented rolling bearing;

FIG. 7 is a curve showing the change in the measured angle as a function of the actual angle;

FIG. 8 is a flowchart of the method step of computing the torque; and

FIG. 9 is a view similar to FIG. 1 of another embodiment.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

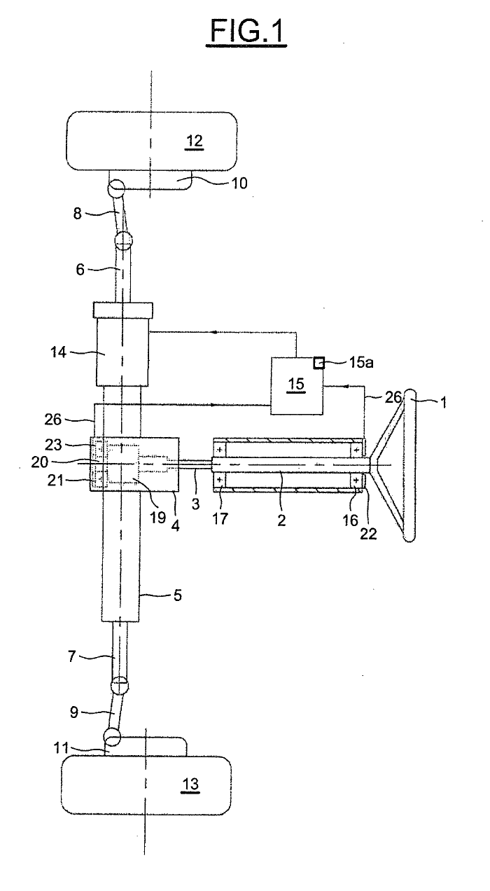

As may be seen from FIG. 1, the steering system includes a steering wheel 1 which may be manipulated by a driver of the vehicle, a steering shaft 2 supporting the steering wheel 1 and rotationally coupled to said steering wheel 1, a torsion bar 3 rotationally coupled to the steering shaft 2 and extending said steering shaft 2 on the opposite side to the steering wheel 1, and a pinion mechanism 4 rotationally coupled to the torsion bar 3 and engaging with a rack mechanism 5. The rack mechanism 5, which is substantially perpendicular to the axis of the steering shaft 2, includes two control bars 6 and 7 whose free ends are connected by ball-type joints to link rods 8, 9. That end of the link rods 8, 9 which is opposed to the bars 6, 7 is connected by another ball joint to the hubs 10, 11 of steered wheels 12, 13 of a vehicle, for example the front wheels. The steering assembly additionally includes an electric assist motor 14 for reducing the torque that the driver has to exert on the steering wheel 1 to turn the wheels 12, 13. The electric motor 14 is controlled by a control unit 15 associated with a memory 15a.

The steering shaft 2 is supported by two rolling bearings 16, 17 mounted in a steering shaft housing 18 which may take the form of a tube. The pinion mechanism 4 includes a pinion 19, through which there passes a shaft 20 which extends the torsion bar 3 on the opposite side to the steering wheel 1. The shaft 20 projects beyond the pinion 19 and is supported by a rolling bearing 21 arranged in a casing of the pinion mechanism 4. The steering shaft 2, the torsion bar 3 and the pinion 20 are rotationally coupled and may be formed as one piece. Alternatively, the pinion shaft 20 is formed in one piece with the pinion 19.

The rolling bearing 17 may be of the conventional type. The rolling bearings 16 and 21 are equipped with an angular detection assembly, designated 22 and 23 respectively. The output of the angular detection assemblies 22 and 23 is connected to the control unit 15, which thus receives information relating to the angular position of the steering wheel 1, the rolling bearing 16 being arranged in the immediate vicinity of the steering wheel 1, and information relating to the angular position of the pinion 19, and may thus generate control orders sent to the assist motor 14 as a function of the angular offset between the rotating parts of the two rolling bearings associated with the detection assemblies. In other words, each detection assembly 22, 23 is remote from the torsion bar 3.

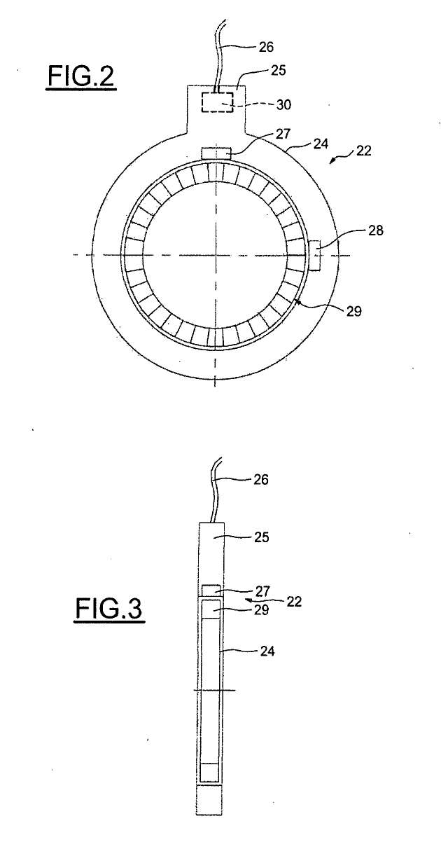

The detection assemblies 22 and 23 may have a similar structure, which is illustrated in more detail in FIGS. 2 and 3. For reasons of simplicity, only the detection assembly 22 will thus be described. The detection assembly 22 includes a sensor block 24 having an annular general shape while being provided with a terminal 25 for a wire output 26 that projects radially outward with respect to the ring formed by the sensor block 24. The terminal 25 is advantageously formed as one piece with the sensor block 24 and made of synthetic material. The sensor block 24 supports two sensors 27 and 28 which are angularly offset and flush with the bore of said sensor block 24. The sensors 27 and 28 may be offset by an angle of 90°. The sensor block 24 has a flat shape bounded between two radial planes and is thus axially compact.

The detection assembly 22 is supplemented by a multipole encoder ring 29 made, for example, of plastoferrite and including a plurality of circumferentially alternating north and south poles. The sensors are arranged angularly with respect to the poles of the encoder ring such that, when the encoder ring 29 rotates with respect to the sensors 27 and 28 secured to the sensor block 24, the sinusoidal electric signals emitted by the sensors 27 and 28 are out of phase by 90°. The output of the sensors 27 and 28 is connected to the wire 26 leading to the control unit 15. The sensors 27 and 28 may be magnetoresistors or else Hall-effect cells.

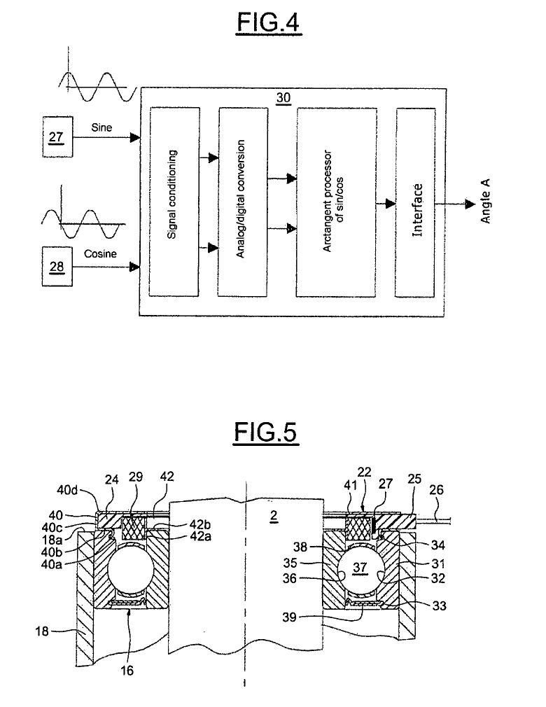

The sensor assembly 22 may include a signal-processing card 30 incorporated into the terminal 25 and receiving the signals from the sensors 27 and 28. The card 30 performs 25 processing operations illustrated in FIG. 4. Alternatively, these processing operations are performed by the unit 15.

As may be seen from FIG. 4, the processing card 30 first of all performs a conditioning operation on the signals received from the sensors 27 and 28, which are generally sine-like and cosine-like signals. The conditioning operation may consist of a filtering operation. In a second step, the card 30 performs an analog/digital conversion on the conditioned signals. In a third step, the processing card 30 applies an arctangent operator to the converted signals in order to supply a signal relating to the angle of displacement between the encoder 29 and a fixed reference of the sensor block 24. In a fourth step, the angular signal is shaped by an interface and then output toward the wire 26. Of course, the card 30 could be situated outside of the instrumented rolling bearing.

The structure of the rolling bearing 16 is illustrated in more detail in FIG. 5. The rolling bearing 16 is mounted between the steering shaft 2 and the tubular housing 18 and includes an outer race 31 provided with an axial outer surface fitted into the housing 18, with two radial end surfaces and with an inner surface in which there is formed a recessed raceway 32 of toroidal shape substantially in the center of said outer race 31 and two grooves 33 and 34 which are symmetrical with respect to a radial plane passing through the center of the raceway 32 and which are arranged in the vicinity of the end surfaces of said outer race 31.

The rolling bearing 16 includes an inner race 35 provided with a bore fitted onto the shaft 2, with two radial end surfaces which are substantially aligned with the end surfaces of the outer race 31, and with an axial outer surface in which there is formed a raceway 36 of toroidal shape. Rolling elements 37, in this case balls, are arranged between the raceways 32 and 36 and are maintained at a uniform circumferential spacing by a cage 38 made of sheet metal. The outer 31 and inner 35 races may be produced by machining a portion of a tube. The outer race 31 supports a seal 39 which is fitted into the groove 33 and whose internal edge of small diameter forms a lip which rubs against the axial outer surface of the inner race 35, thereby providing contact sealing. The seal 39 includes a metal reinforcement and a flexible part which forms the sealing lip.

On that side of the outer race 31 which is axially opposed to the seal 39, a detection assembly 22 is associated with the rolling bearing 16. The detection assembly 22 includes a cup 40, of annular general shape, including a rim projecting into the groove 34 in the outer race 31, a radial portion 40b arranged between the corresponding end surface of the outer race 31 and the sensor block 24, an axial portion 40c surrounding the sensor block 24 and provided with an opening for letting through the wire output terminal 25, and a short oblique rim 40d which is slightly folded inward with respect to the axial portion 40c and which holds a substantially radial flange 41 in place against the outer radial wall of the sensor block 24. The axial portion 40c of the cup 40 has an outside diameter which is very slightly less than that of the outer race 31. The flange 41, which takes the form of a ring, is provided with an inside diameter of the same order of size as the outside diameter of the inner race 35.

The detection assembly 22 also includes the encoder 29, of annular shape with a rectangular cross section, supported by a cup 42, likewise annular and having a T-shaped cross section with an axial portion arranged in the bore of the encoder 29 and partly fitted onto the outer surface of the inner race 35, and an inwardly directed radial portion 42b situated substantially in the middle of the axial portion 42a and in contact with the corresponding end surface of the inner race 35. The radial portion 42b has a radial dimension which is less than that of the inner race 35. The encoder 29 is thus positioned axially with precision on the inner race 35, the radial portion 42b of the support 42 butting against the inner race 35 and being suitably fastened to said inner race 35 by the axial portion 42a fitting onto said inner race 35.

The flange 41 and a thin portion of the sensor block 24 cover the outer radial face of the encoder 29 and, together with said encoder 29, provide narrow passage sealing. The ingress of foreign bodies which are harmful to the rolling bearing or to the encoder is thus prevented. Moreover, the attraction by magnetization of particles of magnetic material toward the encoder 29 is also prevented. A small radial gap remains between the large-diameter axial surface of the encoder 29 and the bore of the sensor block 24, with whose surface the sensors are flush, only the sensor 27 being visible in FIG. 5.

The housing 18 has a free end 18a in the vicinity of the steering wheel 1, this free end being substantially aligned radially with the end surfaces of the outer 31 and inner 35 races on the side toward the detection assembly 22.

Instrumented rolling bearings forming detection and measurement means are thus available. The sensor is mounted on the non-rotating race and the encoder is mounted on the rotating race.

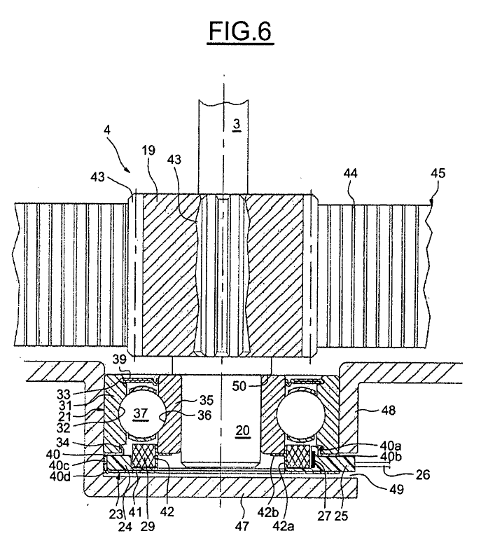

FIG. 6 illustrates in more detail the lower end of the pinion mechanism 4. The pinion 19 includes a set of teeth 43 formed on its outer surface which engages with a corresponding set of teeth 44 on the rack 45, which forms part of the rack device 5. The pinion 19 is mounted on a shaft 20 and is rotationally coupled with said shaft, the pinion 19 and the shaft 20 being arranged in a casing 47 provided with a radial portion 48 in which the rolling bearing 21 associated with the detection assembly 23 is arranged. The radial portion 48 is provided with an opening 49 into which the terminal 25 for the wire output 26 projects. The rolling bearing 21 and the detection assembly 23 are respectively identical to the rolling bearing 16 and the detection assembly 22 described with reference to FIG. 5. The reference numbers are therefore retained. The inner race 35 of the rolling bearing 21 is fitted onto the end of the shaft 20 until it butts against a shoulder 50 of said shaft 20, in the region of the seal 39. The outer race 31 of the rolling bearing 22 is fitted into the radial portion 48 of the housing 47.

A system is thus available which includes an angular detection means in the vicinity of the steering wheel 1, and an angular detection means at the opposite end, that is to say beyond the pinion 19 interacting with the rack 45, thereby making it possible to detect the angular deviation between the rotating parts of the two rolling bearings 16 and 21 by a comparison between the output signals representative of the angle.

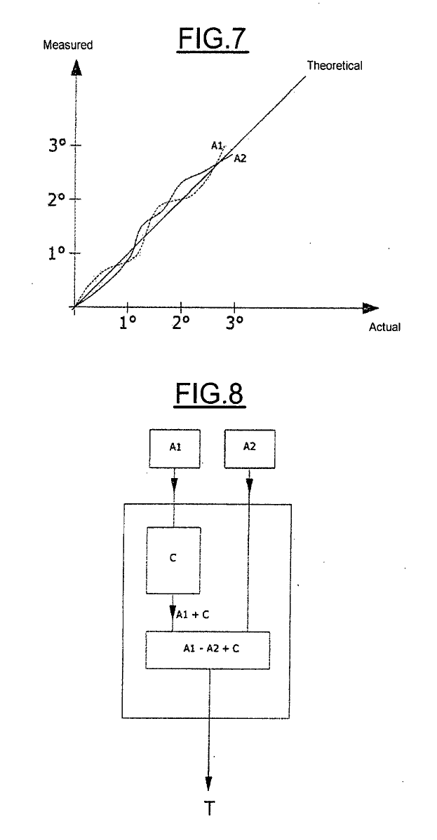

As may be seen from FIG. 7, the values of the angle A₁ measured by the detection assembly 22 and of the angle A₂ measured by the detection assembly 23 do not develop in a strictly linear manner as a function of the actual angle.

The curves of the measured values of A₁ and A₂ therefore deviate from the theoretical curve which is perfectly straight.

This is due to the inevitable imprecisions inherent in the manufacturing tolerances of the various elements. That is why it proves to be particularly advantageous to carry out a determination of the torque using a comparison of said angles that incorporates correction values, see FIG. 8. It will be understood that when the steering wheel 1 is turned, the difference between the angles A₁ and A₂ gives the theoretical value of the angle of the total torsion applied to the mechanical elements situated between the two rolling bearings 16 and 21, that is to say between the upper end of the steering column shaft and the lower end of the torsion bar. The difference between the angle A₁ and the angle A₂ may therefore be used to deduce therefrom the applied torque value, which is proportional to this difference, and to give orders to the assist motor 14 of the steering system, which motor will be prompted proportionally to the measured torque value.

However, in order to satisfy both a sufficient level of precision for this type of application and reasonable manufacturing costs when using mass-produced instrumented rolling bearings, it is necessary to carry out a specific calibration of said rolling bearings. This is because, since the measurement of the torsion angle, and therefore of the torque, is obtained by the difference between the angular positions supplied by the two instrumented rolling bearings, the precision of the measurement depends on the precision of the absolute position measurement over one revolution of each instrumented rolling bearing. By calibrating one instrumented rolling bearing with respect to the other, it is possible to overcome the problems in the precision of the measurements supplied by the instrumented rolling bearings. The term “measurement precision” is intended to mean the deviation between the measurement of the parameter that is supplied by the device and the actual value of the parameter. On account of the manufacturing tolerances and imprecisions, there are deviations between the actual values of the angles and the values measured by the detection assemblies.

The calibration of the two instrumented rolling bearings consists, once the instrumented rolling bearings have been fitted into the steering system, in maneuvering the steering system in the unloaded state with a zero or negligible torque throughout its range of deflection by acting on the steering wheel, and in recording, for each angular position A₁ of the detection assembly 22, the angular position A₂ of the second detection assembly 23, and in establishing and storing in the memory 15a a correction table which gives the correction values C equal to the difference between the angles A₁ and A₂, then in applying said correction value C to the measured angle Al.

Thus, as may be seen from FIG. 8, the memory 15a stores the correction values C as a function of the angle A₁, the processing unit 15 computes the sum of the measured angle A₁ and the correction value C supplied by the memory 15a, and then computes the difference between the sum A₁+C and the measured angle A₂, in order to obtain a value T=A₁−A₂+C which is representative of the torque and which may thus be used by the processing unit 15 to generate control orders which will be sent to the assist motor 14.

Thus, the determination of the torque based on the difference between the angles A₁ and A₂, which difference is corrected by the correction coefficient C, is not adversely affected by any imprecisions in the individual measurements of the instrumented rolling bearings, since the correction coefficient C incorporates the deviations due to the measurement imprecisions between the angles A₁ and A₂. Irrespective of the angle measurement precision of each instrumented rolling bearing, the difference, corrected by the coefficient C, between the angle measurements supplied by the two instrumented rolling bearings is always zero as long as no torsion is applied to the torsion shaft.

When the torque exerted is not zero and produces a torsion in the torsion shaft, the value T=A₁−A₂+C is positive or negative and gives rise to an order to prompt the assist motor 14 and turn the wheels until the torsion angle of the torsion shaft has returned to a value close to zero and a value A₁−A₂+C=0° is hence obtained. The control unit thus stops the assist motor 14.

In other words, if the angle A₁ is the setpoint value demanded by the driver when turning the steering wheel, the calibration allows the system to learn what should be the measured angular value of the angle A₂ so that the final turning of the wheels is correct.

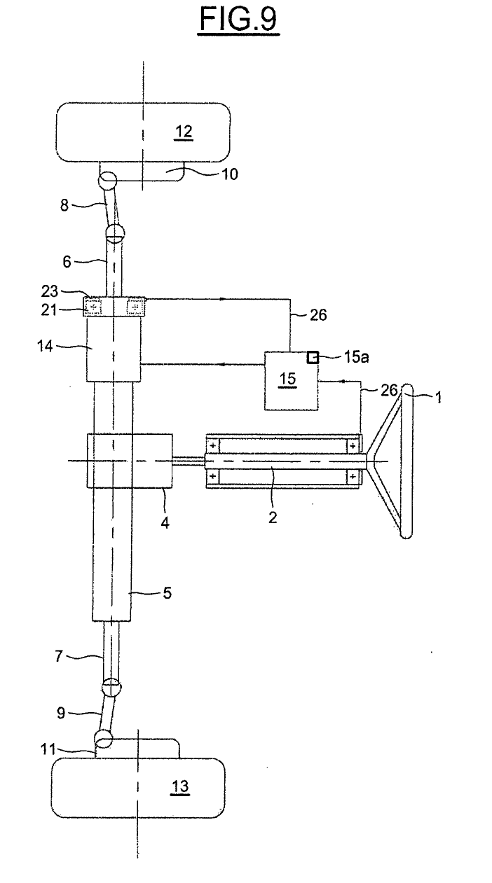

In the embodiment illustrated in FIG. 9, the rolling bearing 21 equipped with the detection assembly 23 forms part of the assist motor 14. There may then be a reduction ratio between the speed of the motor 14 and the speed of the steering column shaft 2. In this case, the correction coefficient C takes into account not only the measurement imprecisions of each rolling bearing, but also the reduction ratio. The measured angle A₁ still remains the angular setpoint position corresponding to the turning angle of the steering wheel and the angle A₂ is that of a rotating part of the assist motor 14, the angle A₂ being representative of the turning angle of the wheels 12 and 13.

Thus, the device makes it possible to know the absolute angular position of the steering column and the torsion of the torsion shaft and, where appropriate, the combined torsions of all the elements arranged between the two detection assemblies with a precision which depends essentially on the resolution and repeatability of the measurement of each detection assembly.

Of course, the steering system may be devoid of a torsion shaft. The detection assemblies are placed at the two ends of the kinematic linkage, as close as possible to the steering wheel in the case of the detection assembly 22 and as close as possible to the wheels 12 and 13 in the case of the detection assembly 23. The torsion measured is thus that of all the members of the steering system and gives the difference between the angular position setpoint of the steering wheel and the turning position of the wheels.

A particularly economical and precise torque-measuring device is therefore obtained.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A device for measuring the torque applied to a kinematic assembly comprising
a control shaft,
a detection means capable of supplying a signal representative of the angular position Al of a first element of said kinematic assembly, and
a detection means capable of supplying a signal representative of the angular position A₂ of a second element of said kinematic assembly, one of the detection means comprising an encoder, a memory for storing a correction value C, and a processing unit provided with means for applying the correction value C to one of the angular positions A₁ or A₂, where C=A₂−A₁ when the torque applied to the kinematic assembly is zero.

2. The device as claimed in claim 1, wherein the detection means are mounted in a steering column also comprising a torsion bar separated from the detection means.

3. The device as claimed in claim 1, wherein a detection means is mounted on a steering element of said kinematic assembly, the angular position of which is representative of the turning angle of the vehicle wheels.

4. The device as claimed in claim 3, wherein said steering element is the input shaft of a rack pinion.

5. The device as claimed in claim 3, wherein said steering element is a rotating member of a steering motor.

6. The device as claimed in claim 1, wherein the detection means comprise encoders mounted beyond the opposite ends of a torsion bar.

7. The device as claimed in claim 1, wherein the detection means comprise absolute angular position sensors.

8. The device as claimed in claim 1, wherein at least one detection means comprises a revolution counter.

9. The device as claimed in claim 1, wherein the detection means comprise magnetosensitive sensors and multipole magnetic encoders.

10. The device as claimed in claim 1, wherein at least one detection means is mounted on a rolling bearing race.

11. A method of measuring the torque applied to a kinematic assembly comprising a control shaft, the method comprising:
measuring, with first detection and measurement means, the angular position A₁ of a first element of said kinematic assembly.
measuring with second detection and measurement means, the angular position A₂ of a second element of said kinematic assembly,
wherein one of the first or second elements is the shaft, and
wherein a correction value C is applied to one of the angular positions A₁ or A₂, where C=A₂−A₁ when the torque applied to the kinematic assembly is zero.

12. The method as claimed in claim 11, wherein the correction value C is established and recorded by relative calibration of the two detection and measurement means during an operation of the kinematic assembly at zero or negligible torque.

13. The method as claimed in claim 11, wherein at least one of the detection and measurement means is an instrumented rolling bearing.
